(19) United States
(12) Patent Application Publication
(10) Pub. No.: US 2005/0168068 A1
(43) Pub. Date: Aug. 4, 2005

(54) Reinforced stud mount

(75) Inventors: Denis Courtemanche, Richmond (CA); Jules Dandurand, Sherbrooke (CA)

Correspondence Address: MERCHANT & GOULD PC, P.O. BOX 2903, MINNEAPOLIS, MN, 55402-0903, US

(73) Assignee: CAMOPLAST INC., Sherbrooke (CA)

(21) Appl. No.: 10/767,917

(22) Filed: Jan. 29, 2004

(51) Int. Cl. B62M 27/02

(52) U.S. Cl. 305/168

(57) ABSTRACT

There is provided a stud mount comprising a stud-receiving passage studs are inserted by force. Each stud is anchored in a stud mount to a reinforced portion of the track independently of reinforcing rods thereof, thereby allowing a reduced complexity of machining of a stud mounting cylinder and strengthened mechanical and traction properties of the track.

### FIELD OF THE INVENTION

The present invention relates to tracked vehicles. More specifically, the present invention is concerned with reinforced stud mounts for tracked vehicles.

### BACKGROUND OF THE INVENTION

A snowmobile is a motor-driven vehicle propelled by an endless-drive track typically formed of a resilient material such as rubber. A number of attempts at improving traction on ice include either relatively complicated or expensive multiple piece assemblies or ice studs.

For example, U.S. Pat. No. 2,040,696 issued to E. A. Johnston on May 12, 1936 describes a grouser assembly. Ice studs are illustrated in U.S. Pat. No. 3,973,808 issued on August 10 to Jansen et al., while U.S. Pat. No. 3,838,894 issued to Donald G. Reedy on Oct. 1, 1974 discloses a so-called “T-nut”, which includes a head mounted on the inside of a snowmobile track and an integral threaded cylinder received in an aperture extending between the inside and outside surfaces of the track, this ice stud being mounted on the outside of a snowmobile track and threadedly received in the outer end of the threaded cylinder. A “push through” ice stud is disclosed in U.S. Pat. No. 5,234,266 issued to James R. Musselman on Aug. 10, 1993, which includes a head disposed on the inside of the track and an integral threaded shank that passes through the snowmobile drive belt and is secured to the belt via a threaded fastener on the outside of the belt.

However, such prior art T-nut and push through style studs require a threaded fastener for securing the stud to the drive belt. Such studs are typically mounted with a backer plate or washer disposed between the stud and the track surface to help laterally stabilize the stud and preclude the stud from pulling through the track. They typically comprise a plurality of parts that need assembling, resulting in a turnaround time required to replace broken studs being lengthy, and the assembly and disassembly of the various stud-mounting components being time consuming. Indeed, such studs are typically not installed in original equipment snowmobile tracks but are installed as after-market items and require the user to drill or cut holes into the track at a plurality of locations throughout the drive belt. The cutting of such holes is time consuming and the user may not optimally place the holes to maximize traction.

The snowmobile drive tracks typically also include transversely extending fiberglass reinforcing bars or rods, which have heretofore been embedded in the track for strengthening the track. Sometimes, the track includes a plurality of laterally spaced apart parallel endless drive belts which have laterally confronting, lateral edges that are integrally coupled together via transversely disposed, integral molded traction lugs. The reinforcing rods span the adjacent parallel belts and are located so as to be embedded in the transverse integrally molded traction lugs for increasing track strength. Such reinforcing rods typically have a semi-circular cross section.

During travel, tremendous transverse forces are exerted on the snowmobile traction studs and the mounts, which thus tend to laterally deflect in the holes provided in the resilient snowmobile drive belt. Studs that are deflected relative to the track tend to deflect or tip into a negative attitude. In a negative attitude, studs will have decreased traction capabilities or holding power than studs, which are not so deflected. Stated another way, during a turn, a deflected stud, rather than assuming a digging position, tends to assume a sliding position.

U.S. Pat. No. 6,264,293 discloses a one-piece stud mount and method of manufacturing same providing a pair of elongate confronting legs that form a traction stud-receiving receptacle and include transversely disposed apertures therethrough for slidably mounting the receptacle on a reinforcing bar that is thereafter embedded in an endless drive track. Such an assembly proves to be complicated.

Accordingly, there is still a need in the art for reinforced stud mounts allowing securing studs into a track for enhanced adhesion to a ground surface and safety.

### SUMMARY OF THE INVENTION

There is provided a stud mount for mounting a traction stud having a barrel part and a tip part in a traction profile lug of a track belt, comprising a stud-receiving passage of a cross section smaller than a cross section of the barrel part of the traction stud; and at least one flange projecting laterally from the stud-receiving passage, wherein the traction stud is anchored into the traction profile lug by inserting the barrel part thereof in said stud-receiving passage by force, in a press-fit engagement, the tip part thereof projecting out of the traction profile lug.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a fragmentary side view of a track provided with stud mounts according to an embodiment of the present invention; and

FIG. 2 illustrates a stud that may be used in the track of FIG. 1;

FIG. 3 is a schematical view of a stud mount provided in the track of FIG. 1.

### DESCRIPTION OF SPECIFIC EMBODIMENTS

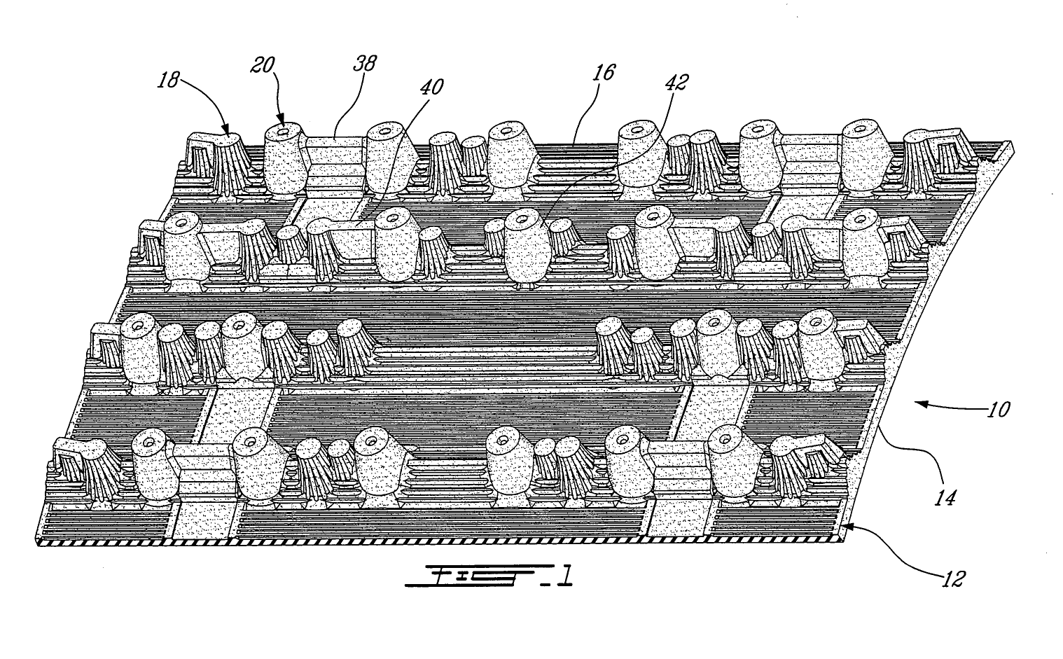

As illustrated in FIG. 1 of the appended drawings, a track, such as a track for a snowmobile for example, generally designated 10, comprises an endless drive belt 12 trained around drive sprockets or wheels (not shown) for driving the belt 12 in an endless path.

The endless belt 12 may be made of a resilient material such as a flexible rubber or flexible rubber reinforced to strengthen the track 10, as is well known to people in the art.

The belt 12 has an inner surface 14 and an outer surface 16, which, as it passes along a lower run of the belt 12, engages a surface (not shown) to be traversed. The inner surface 14 is provided with spaced drive lugs (not shown) which are spaced along a length thereof for engaging drive wheels (not shown) as usual.

The outer surface 16 has typically a cone-shaped profile, comprising a plurality of traction lugs 18 and 20 integrally formed with the track 10. These traction lugs engage the surface to be traversed (not shown) and snow for an increased traction effect.

Typically, studs are inserted into the traction lugs 20 by means of a stud mount, as will be described hereinbelow.

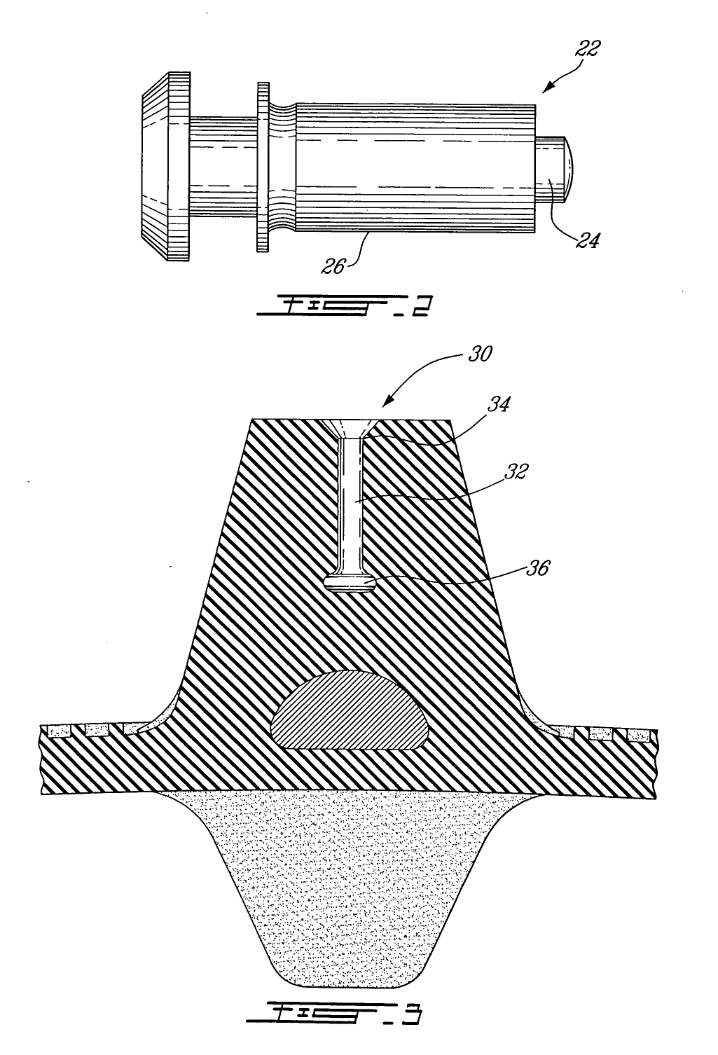

As illustrated in FIG. 2, a stud 22 typically comprises a tip 24 and a barrel 26.

The tip 24, very hard and wear resistant, may be made, for example, in a hard material such as carbon or tungsten carbide. Projecting out of the traction lug 20, the tip 24 allows adherence to the ground surface (not shown).

The barrel 26, typically made in a light material such as aluminum or in a plastic material, supports the tip 22 and allows for a tight anchorage of the stud 22 into the traction lug 20.

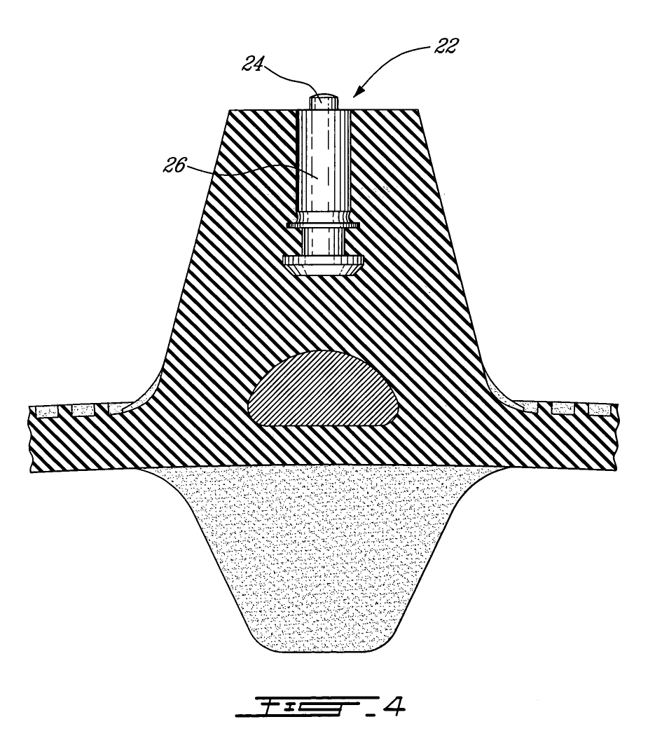

Referring now to FIG. 3, a stud mount, generally designated 30, will be described.

The stud mount 30 comprises a stud-receiving passage 32 that may be provided with flanges, which are rims or edges projecting laterally therefrom that match complementary shaped shank of a stud to be mounted therein (see FIG. 2). A number of such flanges may vary according to the type of vehicle (heavy road vehicle etc.). In the example illustrated in FIG. 3, a flange 34 is provided along the stud-receiving passage 32 and a bottom flange 36 is provided at a bottom end thereof.

The track 10 may further comprise, embedded in the belt 12, a plurality of spaced apart, transversely extending reinforcing rods or bars (not shown). It is to be noted that the flange 36 of the stud mount 30 is located below an underside of the reinforcing bar. Therefore, in such tracks bearing reinforcing rods, the stud mount of the present invention allows a mounting of the studs into the profile of the track 10 independently of the reinforcing rods.

The stud mount 30 is molded into the traction lug 20 during a manufacturing stage of the track 10 so as to define the stud-receiving passage 32. A cross section of the stud-receiving passage 32 is made to be smaller than a cross section of the barrel 26 of a stud to be received, for example by half the size. Studs are thus inserted therein by force, in a press-fit engagement, during manufacture of the track 10.

As may be seen in FIG. 1, the lugs 20 which have a stud embedded therein, are reinforced, either by being supported on both sides by a lug 18 (see stud 42 on FIG. 1 for example), or by being supported on one side by a lug 18 and on the other side by a reinforcing section 40, or by being supported on one side by a reinforcing section 38.

Obviously, the stud mounts 30 may vary in number and location.

By providing stud mounts allowing for studs to be mounted at the location of lug profiles of the belt for engagement with the surface to be traversed (not shown), wherein each stud is anchored in a stud mount to a rigid portion of the track independently of the reinforcing rods thereof, the present invention allows a reduced complexity of machining of stud-receiving passages, since it is not required that the stud be mounted onto the reinforcing rods; as well as strengthened mechanical properties of the track due to a decoupling between the reinforcing rods and the studs.

People in the art will appreciate that such stud mounts may also be used in tracks devoid of reinforcing rods.

Therefore, there is provided reinforced stud mounts for securing traction studs on an endless drive track, which allow eliminating the need for a separate fastener and utilizing a decreased number of parts, thereby facilitating the manufacturing of tracks.

Moreover, there is provided stud mounts that allow for an enhanced production of an original equipment endless resilient drive comprising stud mounts embedded therein and an increased speed of manufacture and assembly of an original equipment studded snowmobile drive belt.

Interestingly, the present stud mounts allow minimizing deflection of a traction stud mounted on an endless resilient drive belt, and improves the traction capability of studs mounted therein.

Although the present invention has been described hereinabove by way of embodiments thereof, it may be modified, without departing from the nature and teachings of the subject invention as recited in the appended claims.

1-2. (canceled)

3. A stud mount for mounting a traction stud having a barrel part and a tip part in a traction profile lug of a track belt, comprising:
a stud-receiving passage of a cross section smaller than a cross section of the barrel part of the traction stud; and
at least one flange projecting laterally from said stud-receiving passage:
wherein the traction stud is anchored into the traction profile lug by inserting the barrel part of the traction stud in said stud-receiving passage by force, in a press-fit engagement, the tip part of the traction stud projecting out of the traction profile lug, wherein the traction profile lug being integrally formed with the track belt and the stud mount is being formed into the traction profile lug during a manufacturing stage of the track belt.

4. The stud mount according to claim 3, wherein the track belt further comprises a plurality of embedded transversely extending reinforcing rods and said stud mount anchors the stud into the traction profile lug independently of the reinforcing rods.

5. The stud mount according to claim 3 claim 1, wherein said tip part of the traction stud comprises one of the carbon and tungsten carbide.

6. The stud mount according to claim 3 claim 1, wherein said barrel part of the traction stud comprises one of aluminum and a plastic material.

7. A track comprising an endless drive belt of a resilient material trained around drive sprockets for driving the endless drive belt in an endless path, the endless drive belt having an inner surface and a ground-engaging surface comprising a plurality of traction lugs integrally formed with the track, wherein at least some of the plurality of traction lugs are provided with a traction mount according to claim 3.

8. A stud mount for mounting a traction stud in a traction profile lug of a track belt, comprising a stud-receiving passage, said stud mount being molded in the traction profile lug of a track belt, the traction stud being anchored into the traction profile lug by insertion in said stud-receiving passage by force, in a press-fit engagement.

9. The stud mount according to claim 3, wherein the traction profile lug is reinforced by one of: a lug on each side thereof; a lug on a first side thereof; and a reinforcing section on a second side thereof, and reinforcing section on one side thereof.
